(19) United States
(12) Patent Application Publication
(10) Pub. No.: US 2008/0102186 A1
(43) Pub. Date: May 1, 2008

(54) GELLED VEGETABLE OIL CONDIMENT UTILIZING GLYCEROL AND HYDROPHILIC MICROPARTICULATE SILICON DIOXIDE

(76) Inventor: Daniel Perlman, Arlington, MA (US)

Correspondence Address: WESLEY B. AMES, 7031 LOS VIENTOS SERENOS, ESCONDIDO, CA, 92029, US

(21) Appl. No.: 11/555,277

(22) Filed: Oct. 31, 2006

(51) Int. Cl. A23D 9/00

(52) U.S. Cl. 426/601; 426/573

(57) ABSTRACT

An orally dispersible, substantially water-free edible oil-based gel composition for food use, that typically contains between 74% and 99% by weight triglyceride-based edible oil, up to 2.0% by weight hydrophilic microparticulate silicon dioxide, between 0.1% and 1.0% by weight of at least one edible polyol, less than 1% by weight water and less than 25% by weight of additional suspended solids. The polyol and the silicon dioxide have been fully dispersed in the oil-based composition to cause gelling of the edible oil. The composition commonly includes added flavoring agents and can include flavor enhancers.

### RELATED APPLICATIONS

NOT APPLICABLE.

### FIELD OF THE INVENTION

The present invention relates to orally dispersible, edible oil-based compositions, and to two food additives, namely hydrophilic microparticulate silicon dioxide and a polyol dispersed in an edible oil, as well as to foods prepared using such compositions.

### BACKGROUND OF THE INVENTION

The following discussion is provided solely to assist the understanding of the reader, and does not constitute an admission that any of the information discussed or references cited constitute prior art to the present invention.

Over recent decades, a variety of different agents including hard fats, microparticulate silicon dioxide (both hydrophilic and hydrophobic silica) and silica gel (made by combining HCl with sodium silicate) have been used to gel or thicken triglyceride-based edible oils and stabilize suspensions of ingredients in such oils.

Dobson in U.S. Pat. No. 3,360,376 describes the mixing of 10%-15% hydrogenated triglyceride hardstock with 85%-90% liquid triglyceride to produce a thixotropic shortening.

Japikse in U.S. Pat. No. 3,397,997 describes an oleaginous gel composition prepared by rapidly crystallizing a melted mixture containing from about 92% to 99% glyceride oil and from about 1% to 8% solid triglyceride consisting essentially of a blend of beta-phase-tending and non-beta-phase tending hardstocks in a ratio ranging from about 1:4 to about 4:1.

Shuford et al. in U.S. Pat. No. 4,375,483 describe a flavor-enhancing fat composition containing up to about 4% by weight salt, up to about 0.5% by weight lecithin, and a hydrophilic fumed silica (up to about 2% by weight of the salt, i.e., 0.08% of the composition), in which the silica decreases the settling rate of the salt in the presence of lecithin when the fat is heated.

Heine et al. in U.S. Pat. No. 4,605,563 describe a synergistic process for increasing the viscosity of a low viscosity edible oil by adding: (A) from 1% to 10% by weight of a high-melting glyceride of saturated fatty acids, including mono-, di- and triglycerides of palmitic and stearic acids for example, and (B) from 2% to 10% by weight of a highly dispersed microparticulate pyrogenic silica where the weight ratio of (A) to (B) is between 25:75 and 50:50.

Frost et al. in U.S. Pat. No. 4,652,458 describe an edible thermally irreversible silica gel plus lipid, gel composition (such as a non-waxy, no-melt chocolate) that includes one part silica gel and about 1 to about 100 parts lipid.

El-Nokaly et al. in U.S. Pat. No. 5,370,892 describe a non-digestible fat useful in formulating, for example, reduced calorie fat cooking and salad oil compositions made by combining a non-digestible oil having a melting point below about 37 degrees C. and a sufficient amount of hydrophobic colloidal silica (e.g., from 0.5% to about 15%) that is made by chemically modifying the Si—OH groups on the surface of the silica using halosilanes, alkoxysilanes, silazanes and siloxanes.

El-Khoury et al. in U.S. Pat. No. 6,403,144 describes a food preparation composition and a process (U.S. Pat. No. 6,544,574) in which the composition has a reduced number of calories, is anti-foaming when used in frying, and provides anti-stick, anti-spatter, and browning properties. The composition includes an anti-stick agent such as lecithin and/or fumed silica, a flavor enhancing agent (e.g., MSG, nucleotides and maltol), and an anti-foam agent such as fumed silica or silicone polymer may further include at least one edible oil in which about 1.5% to about 2.2% of the hydrophilic fumed silica is added and homogenized into the oil base, after which the additional ingredients are added.

Perlman in U.S. Pat. No. 5,962,064 describes peanut butter (a comminuted peanut suspension that, by nature, contains approximately 50% by weight particulate peanut solids and 50% by weight peanut oil), in which the peanut butter is partially hardened to prevent oil separation by addition of either silicon dioxide or polyol or optionally both.

Finkel in U.S. Pat. No. 4,980,192 describes a method of increasing the viscosity of a chocolate composition containing cocoa butter above the normal melting point of the composition by adding between 0.4% and 5% by weight of a liquid polyol such as glycerol to the chocolate.

Shoaf et al., U.S. Pat. No. 3,669,681 describes a heat-stable shortening for use as an ingredient in heated food products such as fillings and toppings. By example (e.g., Example II), their shortening compositions allow a substantial level of water to be present, e.g., 13% by weight. The shortening compositions of Shoaf et al. may also contain up to 11% of colloidal silicon dioxide and up to 7% of a polyol bridging compound such as glycerol or propylene glycol. The inclusion of substantial amounts of water in some of the described shortenings strongly suggests that Shoaf et al. utilize a hydrophobic colloidal silica throughout their patent because such substantial levels of water would interfere with hydrophilic silica gel formation.

### SUMMARY OF THE INVENTION

This invention provides a composition and method for producing a stably gelled but orally dispersible oil-based food composition. These compositions are substantially water-free edible oil-based gels formed through the combined use of at least two food additives including: (i) hydrophilic microparticulate silicon dioxide such as hydrophilic fumed silica, and (ii) an edible polyol such as glycerol or propylene glycol. These food additives are generally recognized as safe (GRAS), and are used at FDA-approved levels. Thus, silicon dioxide is added at a level that does not exceed 2.0% by weight of the final gelled food product. In addition, the polyol(s) is/are preferably used at a level that does not exceed 1.0% by weight of the final product. Any suspended solid material such as particulate herbs, grated cheese and the like (in addition to the suspended silicon dioxide) is sufficiently low that when blended with the oil, the blend remains a liquid and in many cases is limited to less than 25% of the final product. Free water in the subject composition is usually limited to less than 1.0% of the final product.

The present oil-based gels are particularly advantageous for providing flavored coatings for other food items. Although oil-based gels of the present invention may be used with unheated food, the gels have unique properties when used on heated food. That is, the gels will not melt when heated owing to the stability of the silicon dioxide-polyol hydrogen-bonded gel structure within the oil. Therefore, the gel is suitable for baking, grilling, and toasting applications, where the persistence of an oil coating or glaze on a food is desirable. For example, the oil gel coating may be spread or brushed onto meat, poultry, fish, vegetables, pizza, bruschetta, sliced Italian and French breads, croutons, bagels, toast and the like that may be baked or grilled in a conventional oven, heated in a microwave oven, barbecued, toasted or otherwise heated. In spite of this heat-stability, when the gel combines with moisture in the mouth, the hydrogen-bonded silica-polyol gel structure is lost, and the oil disperses as a liquid, providing an excellent (non-greasy and non-waxy) mouth feel and flavor dispersion. In many cases in which it is desired to use the oil-based gel as such an oil coating or glaze, the oil-based gel can include at least one flavoring agent, such as spice mixes, cheese, and the like.

Accordingly, in a first aspect, this invention provides an orally dispersible, substantially water-free edible oil-based gel composition for food use, that is, the entire composition is edible. The composition includes from 74% to 99% by weight triglyceride-based edible oil(s) and/or fats, from 1.0% to 2.0% by weight hydrophilic microparticulate silicon dioxide, from 0.1% to 1.0% by weight of at least one edible polyol, less than 25% of additional suspended solids, and less than 1% by weight of available water. The polyol and the silicon dioxide are fully dispersed in the oil-based composition, for example, to cause gelling of the edible oil.

In certain embodiments, the edible oil-based gel composition includes at least one edible oil selected from the group consisting of olive oil, canola oil, safflower oil, sunflower oil, corn oil, cottonseed oil, soybean oil, peanut oil, palm oil, fractions of palm oil, palm kernel oil, flaxseed oil, anhydrous butterfat, tallow, lard, mutton fat, fish oil and combinations thereof; the edible oil (which may be a single oil or a combination of edible oils) is substantially free from trans fatty acids; the oil is a combination which includes olive oil; the oil is a combination which includes canola oil, the oil is a combination which includes corn oil; the oil is a combination which includes soybean oil.

In particular embodiments, the form of hydrophilic microparticulate silicon dioxide that is utilized is amorphous fumed silica, amorphous silica gel, pyrogenic silica, colloidal silica, silica aerogel, or crystalline silica; the primary particle diameter of hydrophilic silicon dioxide microparticles is in the range of approximately 0.003 to 0.080, 0.003 to 0.050, 0.003 to 0.030, 0.005 to 0.050, 0.005 to 0.030, 0.005 to 0.020, or 0.010 to 0.030 microns; the concentration of hydrophilic microparticulate silicon dioxide in the edible oil-based gel composition is from 1.0 to 1.5, 1.3 to 1.7, 1.5 to 1.8, 1.7 to 1.9, or 1.8 to 2.0% by weight; the weight ratio of polyol to silicon dioxide is from 1:20 to 1:2, 1:20 to 1:15, 1:20 to 1:10, 1:15 to 1:5, 1:10 to 1:2, 1:10 to 1:5, or 1:5 to 1:2; the amounts and ratios of hydrophilic microparticulate silicon dioxide are selected such that they provide both enhanced gelling and reduced oil release from the gel composition.

In particular embodiments, the polyol is soluble in the edible oil (which can, for example allow the gelled oil to remain optically transparent). For example, up to 4% by weight glycerol can be solubilized in a triglyceride-based oil. In particular embodiments, the polyol used in the edible oil-based gel composition is selected from the group consisting of polyhydric alcohols, esters of polyhydric alcohols and combinations thereof; the polyol is selected from the group consisting of glycerol, fatty acid monoglycerides and combinations thereof; the concentration of polyol used in the edible oil-based gel composition is 0.1 to 0.5, 0.3 to 0.5, 0.3 to 0.7, 0.5 to 1.0, 0.5 to 0.7, 0.7 to 1.0% by weight.

In particular embodiments, the concentration of available water is less than 0.9, 0.8, 0.7, 0.6, 0.5, or 0.4% by weight.

In certain embodiments, the gelled oil-based composition is stable when heated; the gelled oil-based composition remains gelled at up to at least 60, 80, 100, 120, 140, 150, 160, 170, 180, or 190° C.

In preferred embodiments, at least one flavoring ingredient is added to the edible oil-based gel composition; the at least one flavoring ingredient includes an acidifying agent; the at least one flavoring ingredient is selected from the group consisting of garlic, onion, cheese, salt, pepper, hot pepper, herb flakes or powder, mustard, balsamic vinegar, Worcestershire sauce, and combinations thereof. In certain embodiments, a combination of flavor enhancers is included, e.g., sodium chloride or potassium chloride with a second type of flavor enhancer such as an amino acid-type flavor enhancer (e.g., a glutamate or L-theanine), a nucleotide flavor enhancer (e.g., as guanylates, inosinates, salts of 5′-ribonucleotides, and corresponding acids), yeast extract, or seaweed (or extract) flavor enhancer, among others.

In certain embodiments, the composition is selected from the group consisting of condiments, glazes, spreads, and toppings. Such compositions are typically applied directly to food products. In general, the composition is not used, nor is it useful as a shortening ingredient in other foods.

In a related aspect, the invention concerns an orally dispersible, substantially water-free edible oil-based gel composition for food use. The composition includes at least one triglyceride-based edible oil(s) and/or fats, a sufficient amount of a combination of hydrophilic microparticulate silicon dioxide and edible polyol to provide gelling of the composition while not exceeding a level of silicon dioxide approved as generally accepted as safe (GRAS) and such that the ratio of polyol to silicon dioxide is from 1:20 to 1:2, a sufficiently low concentration of additional suspended solids that a combination of the edible oil(s) and the additional solids in the absence of the silicon dioxide and polyol will be liquid at 50° C., and a sufficiently low concentration of available water that the composition remains stably gelled for a period of at least 7 days, preferably at least 30 days.

In particular embodiments, the selections of edible oil(s), hydrophilic microparticulate silicon dioxide, polyols, flavoring agents, and/or additional solids, and/or the amounts of such components, are as indicated for the aspect above. Also in particular embodiments, the composition is of a type as indicated for the aspect above and/or the physical characteristics of the composition (e.g., response to heating) are as indicated for the preceding aspect.

In certain embodiments, the sufficiently low concentration of additional suspended solids such that a combination of the edible oil(s) and the additional solids in the absence of the silicon dioxide and polyol will be liquid at 50° C. results in a viscosity at 50° C. for the oil+additional solids blend of not more than about 3000 centipoise (cps) using a Brookfield viscometer (or even not more than 2500, 2000, 1500, 1000, 800, or 700 cps). In the case that the blend behaves as a non-Newtonian fluid which evidences shear-thinning, the viscosity is the viscosity in the high shear limit.

In another aspect, a method is provided for preparing an orally dispersible, substantially water-free, gelled oil-based food coating composition that includes from 74% to 99% by weight triglyceride-based edible oil, from 1.0% to 2.0% by weight hydrophilic microparticulate silicon dioxide, from 0.1% to 1% by weight of at least one edible polyol, less than 25% of additional suspended solids, and less than 1% by weight of available water. The method includes the steps of (i) adding to a triglyceride-based edible oil, between 1.0% and 2.0% by weight hydrophilic microparticulate silicon dioxide, and between 0.1% and 1% by weight of at least one edible polyol, and (ii) homogenizing the mixture until the silicon dioxide and the polyol are fully dispersed in the edible oil.

In a related aspect, the method provides an orally dispersible, substantially water-free edible oil-based gel composition for food use that includes at least one triglyceride-based edible oil(s) and/or fats, a sufficient amount of a combination of hydrophilic microparticulate silicon dioxide and edible polyol to provide gelling of the composition while not exceeding a level of silicon dioxide approved as generally accepted as safe (GRAS) and such that the ratio of polyol to silicon dioxide is from 1:20 to 1:2, a sufficiently low concentration of additional suspended solids that a combination of the edible oil(s) and the additional solids in the absence of the silicon dioxide and polyol will be liquid at 50° C., and a sufficiently low concentration of available water that the composition remains stably gelled for a period of at least 7 days, preferably at least 30 days. The method involves (i) adding to a triglyceride-based edible oil sufficient amounts of hydrophilic microparticulate silicon dioxide, and at least one edible polyol in a ratio of polyol to silicon dioxide from 1:20 to 1:2 to provide gelling of the composition while not exceeding an approved level of silicon dioxide (preferably not exceeding a level approved as GRAS), and (ii) homogenizing the mixture until the silicon dioxide and the polyol are fully dispersed in the edible oil.

In particular embodiments, the gelled edible oil-based composition is a composition as described for the aspects describing compositions above or otherwise described herein.

In particular embodiments of the preceding methods, a first homogenizing step is performed after adding the silicon dioxide but before adding the polyol, and a second homogenizing step is performed after adding the polyol, in which the hydrophilic microparticulate silicon dioxide and the polyol are fully dispersed in the edible oil; homogenizing is performed in a single step following addition of both the hydrophilic microparticulate silicon dioxide and the polyol to the oil.

In certain embodiments, the edible oil-based gel composition includes at least one edible oil selected from the group consisting of olive oil, canola oil, safflower oil, sunflower oil, corn oil, cottonseed oil, soybean oil, peanut oil, palm oil, fractions of palm oil, palm kernel oil, flaxseed oil, anhydrous butterfat, tallow, lard, mutton fat, fish oil and combinations thereof; the edible oil (which may be a single oil or a combination of edible oils) is substantially free from trans fatty acids; the oil is a combination which includes olive oil; the oil is a combination which includes canola oil, the oil is a combination which includes corn oil; the oil is a combination which includes soybean oil.

In particular embodiments, the form of hydrophilic microparticulate silicon dioxide that is utilized is amorphous fumed silica, amorphous silica gel, pyrogenic silica, colloidal silica, silica aerogel, or crystalline silica; the primary particle diameter of hydrophilic silicon dioxide microparticles is in the range of approximately 0.003 to 0.080, 0.003 to 0.050, 0.003 to 0.030, 0.005 to 0.050, 0.005 to 0.030, 0.005 to 0.020, or 0.010 to 0.030 microns; the concentration of hydrophilic microparticulate silicon dioxide in the edible oil-based gel composition is from 1.0 to 1.5, 1.3 to 1.7, 1.5 to 1.8, 1.7 to 1.9, or 1.8 to 2.0% by weight; the weight ratio of polyol to silicon dioxide is from 1:20 to 1:2, 1:20 to 1:15, 1:20 to 1:10, 1:15 to 1:5, 1:10 to 1:2, 1:10 to 1:5, or 1:5 to 1:2; the amounts and ratios of hydrophilic microparticulate silicon dioxide are selected such that they provide both enhanced gelling and reduced oil release from the gel composition.

In particular embodiments, the polyol is soluble in the edible oil (which can, for example allow the gelled oil to remain optically transparent). For example, up to 4% by weight glycerol can be solubilized in a triglyceride-based oil. In particular embodiments, the polyol used in the edible oil-based gel composition is selected from the group consisting of polyhydric alcohols, esters of polyhydric alcohols and combinations thereof; the polyol is selected from the group consisting of glycerol, fatty acid monoglycerides and combinations thereof; the concentration of polyol used in the edible oil-based gel composition is 0.1 to 0.5, 0.3 to 0.5, 0.3 to 0.7, 0.5 to 1.0, 0.5 to 0.7, 0.7 to 1.0% by weight.

In particular embodiments, the concentration of available water is less than 0.9, 0.8, 0.7, 0.6, 0.5, or 0.4% by weight.

In certain embodiments, the gelled oil-based composition is stable when heated; the gelled oil-based composition remains gelled at up to at least 60, 80, 100, 120, 140, 150, 160, 170, 180, or 190° C.

In preferred embodiments, at least one flavoring ingredient is added to the edible oil-based gel composition (e.g., added to the oil before homogenization of the oil-silicon dioxide-polyol combination, or added after homogenization of the oil and silicon dioxide, or added after homogenization of the oil-silicon dioxide-polyol combination. In particular embodiments, the at least one flavoring ingredient includes an acidifying agent; the at least one flavoring ingredient is selected from the group consisting of garlic, onion, cheese, salt, pepper, hot pepper, herb flakes or powder, mustard, balsamic vinegar, Worcestershire sauce, and combinations thereof.

In certain embodiments, the resulting composition is selected from the group consisting of condiments, glazes, spreads, and toppings. Such compositions are typically applied directly to food products. In general, the composition is not used, nor is it useful as a shortening ingredient in other foods.

In another aspect, the invention concerns a coated prepared food item which includes a coating of a present orally dispersible, gelled edible oil-based food compositions, e.g., as specified for an aspect above or otherwise described herein.

In particular embodiments, the food item is meat (e.g., beef or pork), poultry (e.g., chicken, turkey, duck), fish, vegetable(s), pizza, bruschetta, sliced Italian or French bread, bagels, croutons, toast, as well as other similar food items. Such coated food items may, as appropriate for the particular food item, be baked or grilled in a conventional oven, heated in a microwave oven, barbecued, toasted, or otherwise heated.

In particular embodiments, the gelled edible oil-based food composition is applied to the prepared food item before baking, broiling, toasting, barbecuing, heating in a microwave oven, or otherwise heating the prepared food item, such that the coated prepared food item is heated in the indicated manner.

In particular embodiments, at least 30, 40, 50, 60, 70, 80, or 90 % of the applied gelled edible oil-based food composition which remains initially adhered to the surface of the food item remains on the surface of the food item (as distinguished from absorption into) following a period of one hour at 25° C. and/or following exposure of the coated surface to an oven temperature of 60, 80, 100, 120, 140, 150, 160, 170, 180, or 190° C. for 10 minutes (or in some embodiments, 15, 20, 30, 40, or 60 minutes).

Likewise, in a related aspect, the invention concerns a method for preparing a coated prepared food item by applying to a food item a flavored substantially water-free gelled edible oil-based composition as described herein for the present invention, e.g., as described in aspects specified above. For example, the method results in a coated prepared food item as described for the preceding aspect.

Thus, in particular embodiments, the gelled oil-based composition includes 74% to 99% by weight triglyceride-based edible oil, from 1.0% to 2.0% by weight hydrophilic microparticulate silicon dioxide, from 0.1% to 1.0% by weight of at least one edible polyol, less than 25% of additional suspended solids, and less than 1% by weight available water, and in which the polyol and silicon dioxide have been fully dispersed in the composition causing gelling of the edible oil.

In certain embodiments, the composition is applied before cooking; the composition is applied after cooking; the composition is applied while the food item is hot; application of the composition is preformed while the food item is at no more than 25 degrees C. and the food item is heated following application of the composition.

In particular embodiments, the food item to which the gelled edible oil-based compositions is applied is meat, poultry, fish, vegetables, pizza, bruschetta, sliced Italian and French breads, bagels, croutons, or toast.

Additional embodiments will be apparent from the Detailed Description and from the claims.

### DETAILED DESCRIPTION OF THE PREFERRED EMBODIMENTS

As described in the Summary above, the present invention concern stable, orally dispersible, substantially water-free gelled edible oil-based compositions which are themselves edible. These gelled edible oil-based compositions are produced through the combined use of two food additives: (i) hydrophilic microparticulate silicon dioxide such as hydrophilic fumed silica, and (ii) an edible polyol such as glycerol or propylene glycol. These food additives are generally recognized as safe (GRAS), and are used at FDA-approved levels. Thus, in general, according to current FDA approved levels, the silicon dioxide does not exceed 2.0% by weight of the final gelled food product. The polyol(s) is/are used at a level effective to provide desired bridging within the gel while avoiding undesired effects such as excessive perceived sweetness. In many case, the polyol(s) are used at a level that does not exceed 1.0% by weight of the final product. Any suspended solid material such as particulate herbs, grated cheese and the like (in addition to the suspended silicon dioxide) is limited to an amount such that a blend of the additional solid material with the oil(s) will be liquid at a temperature at least 10° C. above the melting point of the oil. In most cases, the additional solids will constitute less than 25% of the final product. Free water in the subject composition is limited to an amount which does not substantially interfere with stable gelling, in most cases less than 1.0% of the final product. Preliminarily, it will be useful to define certain terms as used the context of the present invention and the associated claims. Thus, the following terms have the indicated meanings:

### DEFINITIONS

As used in connection with the present compositions, the term “orally dispersible” means that the gelled, edible oil-based compositions will substantially liquefy in the aqueous fluids normally present in the mouth of a person consuming the composition or a food item coated with the composition. This is in contrast to dispersion due to mechanical division and/or enzymatic action, although such mechanisms may also act on the present compositions.

The term “substantially water-free” as it relates to edible oil-based gel compositions of the present invention means that the percentage of free and available water, i.e., chemically available water dispersed in the composition, is less than approximately 2% by weight, and in most cases less than approximately 1% by weight. Preferably, the level of available water is kept below 0.5% by weight, and most preferably below 0.25% by weight. For example, Applicant has observed that when as little as 0.25% by weight water is added and uniformly dispersed (e.g., by high sheer mixing) in an oil-based gel (e.g., a gel containing 97.5% by weight olive oil+2% by weight hydrophilic Cab-O-Sil® M5 fumed silica +0.5% glycerol), the gel viscosity begins to decrease. As more water is added, the gel continues to lose viscosity, becomes increasingly cloudy, and diminishes in utility. When greater than 1%-2% by weight water is added, the utility of the gel is essentially lost.

The term “available water” (aka “chemically available water” or “free water”) is water that is accessible, i.e., readily reactable, with soluble and/or colloidal substances in the oil-based gel composition, including the polyols and suspended silica microparticles, and capable of freely diffusing within the gel composition. Available water is distinguished from bound water in the composition, the latter of which is physically or chemically sequestered by, or immobilized in an edible but non-gelling material within the gel composition. Available water can readily associate with hydrophilic silica and/or polyol constituents in the gel composition. A non-gelling material is any material residing within the gel composition that does not functionally participate in gel formation. Gel materials include edible oil or fat, hydrophilic silica and polyols. It is believed that association of available water in the composition with hydrophilic silica and/or polyols interferes with hydrogen bonding and bridge formation between the polyol molecules and silica microparticles that form the gel. By contrast, sequestered water is water that is tied up and unavailable for binding to microparticulate silica and/or polyol. Sequestered water may be present in the composition in various forms. For example, certain levels of water may be tightly bound up in hydrated salts or in particles of herbs, spices and/or cheese for example, and will not significantly interact with silica particles and/or polyols to adversely affect gel stability. Thus, Applicant has found that dried Italian herbs re-hydrated by warming the herbs with an equal weight of salt-saturated balsamic vinegar can retain the endogenous moisture as sequestered or bound water. However, when the same dried herbs were moistened and warmed with twice their weight of salt-saturated balsamic vinegar, the herbs could not sequester all the moisture. Thus, when 2% by weight of the latter moistened herbs were added to a vegetable oil gel containing 2% by weight fumed silica and 0.5% glycerol, the herbs released enough water to cause a loss in gel viscosity and clouding of the previously clear gel.

Keeping the level of unbound water, i.e., chemically available water, in the composition below about 1% helps to maintain oil clarity (minimizing cloudiness in the oil caused by microscopic water droplets), while also minimizing the chance that any microbial organism can grow in the gel if stored at room temperature. Maintaining an acidic pH within any constituents such as herbs and cheese that may be added to an oil-based gel can also be used to prevent microbial growth. As indicated above, water is added to these gel compositions, initiates hydrogen bond formation with the silanol groups of silica and the hydroxyl groups in polyol (e.g., glycerol), and therefore begins to undesirably interfere with polyol in forming bridges between silica microparticles. Furthermore, since water is volatile and boils at 100° C., it can cause splattering of the gel if the gel is suddenly heated.

The term “triglyceride-based edible oil” refers to any edible oil (or blend of oils, optionally including edible fats) whose chemical structure is based upon the triglyceride molecule, and whose physical state is more liquid (i.e., fluid) than solid at room temperature, thereby allowing formation of a gel structure at room temperature (and above) when appropriate amounts and types of both microparticulate silicon dioxide and polyol are added and dispersed in the oil.

The term “additional suspended solids” refers to solid or semi-solid particulate material that is insoluble in edible triglyceride-based oils and is composed of small (micron or sub-micron particle diameter) or substantially larger (multi-micron or even multi-millimeter particle diameter) powders, grains, flakes and other physical forms of edible solid material that contribute flavor, texture and/or color to the final product. As a requirement of, and limitation on the type of suspended solids material that can be added to the composition, the solids cannot substantially interfere with (either chemically or physically) the formation and stability of the oil-based gel. Examples of such suitable additional suspended solids include flakes of herbs, particles of salt and spices such as pulverized sodium chloride powder, granules of black and/or white pepper, particles of dried or semi-dried cheeses such as Parmesan and Romano cheese, yeast extract powder, vegetable and fruit flakes and the like. The weight proportion of additional suspended solids is generally less than 25% by weight of the final product. This 25% proportion limit is in addition to the amount of microparticulate hydrophilic silica contained in the final food composition. The importance of the 25% limit is that the addition of more suspended solids, e.g., 35%, 50% or even higher percentages of solids, has been empirically shown to produce a paste-like rather than a gel-like texture and mouth feel, thereby either compromising or defeating the invention. As an example, natural peanut butter is a suspension consisting of approximately 50% by weight comminuted peanut solids in 50% by weight peanut oil. Adding 1%-2% by weight hydrophilic microparticulate silica and 0.5% by weight glycerol to natural peanut butter produces a paste rather than a gel-like textured product.

The term “hydrophilic microparticulate silicon dioxide” is defined and discussed elsewhere herein. One example thereof is Cab-O-Sil® M5 fumed silica manufactured by the Cabot Corporation (Tuscola, Ill.).

The term “edible polyol” is discussed elsewhere herein. A polyol is any edible substance whose molecular structure includes two or more hydroxyl moieties, and that is either soluble or that can remain homogenously dispersed (at the microscopic level) in an edible liquid oil. The polyol must be capable of forming a molecular bridge between hydrophilic silica microparticles that have been dispersed in an edible oil. Glycerol and glyceryl monooleate are examples of oil-soluble edible polyols while propylene glycol is an example of a dispersible polyol that is essentially insoluble in vegetable oil.

Various forms of hydrophilic silicon dioxide including amorphous fumed silica, amorphous silica gel, pyrogenic silica, colloidal silica, silica aerogel and crystalline silica are well known and defined elsewhere in the art, and are referred to herein.

The term “primary particle diameter” as it refers to silicon dioxide microparticles refers to the weight average diameter of the spherical silica particles that make up the material.

The term “polyols” as used herein includes (as non-limiting examples) polyhydric alcohols, esters of polyhydric alcohols and combinations thereof. Examples of these include glycerol, fatty acid monoglycerides (such as glycerol monooleate and glycerol monostearate) and combinations thereof. Additional edible polyols which may be used include xylitol, iditol, maltilol, sorbitol, mannitol, dulcitol, inositol, erydiritol, lactitol, and propylene glycol.

With regard to selecting the weight ratio of polyol to silicon dioxide, this ratio should be between 1:20 and 1:2. Both enhanced gelling, i.e., maximum viscosity of the oil medium, and little or no oil release from the gelled composition, i.e., limited syneresis, is achieved within this range of ratios.

The term “flavoring ingredient” or “flavoring agent” and like terms refer to any edible food ingredient that influences the taste or flavor of the gelled oil-based composition and that is added to the composition. A non-limiting list of flavoring ingredients includes garlic, onion, cheese, salt, pepper, hot pepper, herb flakes, mustard, balsamic vinegar, Worcestershire sauce, and combinations thereof.

The term “flavor enhancer” or “flavor potentiator” refers to a food additive, which when added to a food enhances or potentiates other flavor components in the food. Such flavor enhancers may have little or no flavor of their own or may contribute in one or more particular flavor areas. As used herein, unless clearly indicated to the contrary, these terms include table salt (and potassium chloride), as well as nucleotide flavor enhancers (such as guanylates, inosinates, salts of 5′-ribonucleotides, and corresponding acids), amino acid flavor enhancers (such as glutamic acid, glycine, and L-theanine, and their corresponding salts), maltol and derivatives such as ethyl maltol, and various natural products and extracts (such as yeast extract, seaweed extract, and the like). Certain such flavor enhancers provide flavor effects sometimes referred to as “umami” or “savory”, and “brothy.” Such flavor enhancers may be used alone or in combination, e.g., table salt with yeast extract.

The term “acidifying agent” refers to an edible substance that may be added to the oil-based gel composition. If a flavoring ingredient is included in the composition, the acidifying agent may be beneficially added before the flavoring ingredient is added to the gel composition. Such agents include the vinegars (e.g., rice vinegar, cider vinegar, balsamic vinegar), citric acid, fumaric acid, lactic acid, malic acid, phosphoric acid, sodium acid sulfate, tartaric acid, as well as salts of these acids, and combinations thereof.

The term “edible oil” refers to any edible liquid triglyceride-based oil, preferably a vegetable oil or blend thereof, including olive oil, canola oil, safflower oil, sunflower oil, corn oil, cottonseed oil, soybean oil, peanut oil, palm oil, fractions of palm oil, palm kernel oil, flaxseed oil, anhydrous butterfat, tallow, lard, mutton fat, fish oil and combinations thereof.

Referring now to a method for preparing a substantially water-free, gelled oil-based food coating composition, the term “substantially water-free” has been defined above. The term “homogenizing” as it refers to the mixture of ingredients refers to the full dispersal of silicon dioxide particles and polyol in the edible oil. Homogenization may be carried out using high shear mixing, e.g., using mixing devices known and used in the food industry, such as an emulsion mill. Full dispersal is recognized when maximum viscosity is achieved.

### Description

As indicated above, the orally dispersible, oil-based gel compositions described in the present invention are substantially free of water, and are typically used alone as food condiments, food glazes, toppings, spreads and other coatings that are generally applied to the surface of heated meat, fish and poultry, unheated or heated breads, crackers and other food products, rather than being used as a shortening ingredient within other food products.

The edible oil (or fat) selected for use in the presently described gels may be essentially any edible oil or combination of edible oils, for example, olive oil, canola oil, soybean oil, corn oil, safflower, sunflower, cottonseed, peanut, palm oil, palm kernel oil, coconut oil, cocoa butter, anhydrous butterfat, and blended combinations thereof. The hydrophilic silica and polyol additives are dispersed in the edible oil using high shear mixing to form a substantially water-free gel that can be used as a foundation composition to which other ingredients may be added to form oil-based condiments, food glazes, dressings and the like.

For the purpose of making condiments and dressings, water-containing ingredients such as vinegar, Worcestershire sauce and hot pepper sauce might be considered attractive flavoring ingredients for the above-described gels. However, Applicant has found that in addition to causing cloudiness in the gel, dispersion of as little as 0.5%-1.0% by weight of these aqueous ingredients throughout the gel causes much of the gel's viscosity to be lost. Without being limited to a particular theory or mechanism, this may be caused by hydration of the silica particles via surface hydroxyl groups, and the resulting loss of hydrogen bonding between silica particles. Additionally, water appears to interfere with the formation of hydrogen-bonded polyol molecular bridges between silica particles and silica particle aggregates in the gel.

While substantial amounts of chemically active or “free” water must be avoided, Applicant has found that small amounts of water or aqueous liquids can be tolerated in the composition of the above-described oil-based gels with certain caveats. In most cases, an amount of water equal to 1% or less by weight of the final composition can be sequestered without substantial loss of the gel structure. For example, aqueous vinegar, Worcestershire sauce and the like, may be sequestered, i.e., bound up, within a solid ingredient such as herbs or cheese that is added to the gels without suffering the above-described loss of gel viscosity. This water sequestration is preferably carried out before adding the aqueous ingredient to the mixture of oil+hydrophilic silica+polyol. For example, small amounts of vinegar may be sequestered in flaked or granular dried spices such as dried basil, oregano, rosemary, parsley, garlic, dried cheeses, and in other edible ingredients such as dried dietary fiber or protein to prevent undesirable clouding and disaggregation of the above gels. Thus, for example, Applicant has combined between a half and one part by weight of salt-saturated aqueous balsamic vinegar with 1 part by weight mixed dried herbs, heated this mixture briefly to 100° C. to promote absorption of the liquid into the herbs, cooled the mixture to room temperature, and finally dispersed these herbs into 100 parts by weight of an edible oil-based gel. Exemplary gels contained olive oil or a blend of 80% by weight canola oil: 20% olive oil that were gelled using 2% by weight Cab-O-Sil® brand M-5 hydrophilic fumed silica +0.5% glycerol. The resulting gels containing suspended herbs with sequestered balsamic vinegar remained substantially clear and fully gelled.

When, however, two parts or three parts (rather than one part) by weight of balsamic vinegar were combined with one part by weight of the same mixture of dried herbs, and likewise mixed into 100 parts of identical oil-based gels (described above), the same gels turned cloudy and lost much of their viscosity. Thus, there appears to be a limit to the proportion of an aqueous liquid that can be successfully sequestered in a given amount of edible material, e.g., dried herbs, that is subsequently added to such oil gels. Also, Applicant believes that different food ingredients such as dried spices, cheeses and the like, when used as vehicles for sequestering an aqueous liquid such as vinegar may bind the liquid, i.e., water, with different affinities. Based upon Applicant's observations, different food ingredients may have different limits for the amount (proportion by weight) of aqueous liquid that may be successfully sequestered and retained within the ingredient before the liquid begins to bleed into the surrounding gel to cause clouding and loss of gel viscosity. Such limits for sequestered liquid can be empirically determined for different food ingredients. For example, in the case of cheese, when between 4% and 10% by weight of either of the grated Italian cheeses, Parmesan and Romano were added to the canola oil-olive oil-based gels described above, the gels lost viscosity, becoming quite fluid a day or two following mixing. However, by warming and drying the two grated cheeses for several hours at 40° C. until their weights had stabilized (before addition to the oil-based gels, with the cheeses typically losing between 17% and 20% by weight moisture), the resulting gels maintained their viscosities. Applicant has concluded that a substantial amount of moisture can bleed from grated cheese into a surrounding oil-based gel unless the cheese has been pre-dried.

The present oil-based gels of the present invention can be used in a large variety of food application. These gels may be readily and advantageously used with unheated food. In addition, the gels can be used on heated food, having unique properties making such uses practical. That is, properly constructed gels do not melt when heated owing to the stability of the silicon dioxide-polyol hydrogen-bonded gel structure within the oil. As a result, the gels can be used in baking, grilling, toasting, and similar heated applications, where the persistence of an oil coating or glaze on a food is desirable. For example, the oil gel coating may be spread or brushed onto meat, poultry, fish, vegetables, pizza, bruschetta, sliced Italian and French breads, bagels, croutons, toast and the like that may be baked or grilled in a conventional oven, heated in a microwave oven, barbecued, toasted or otherwise heated. Even though the gels possess such heat stability, the gel will still liquefy in a person's mouth because when the gel combines with moisture in the mouth, the hydrogen-bonded silica-polyol gel structure is lost, and the oil disperses as a liquid, providing an excellent (non-greasy and non-waxy) mouth feel.

The present invention can be clarified by distinction from previously described food products containing silicon dioxide. For example, in contrast to Heine et al., U.S. Pat. No. 4,605,563, in which edible oil is thickened with hydrophilic silica and high melting glyceride, the present invention provides a thixotropic heat-stable oil gel with the coordinated use of at least one polyol and up to 2% by weight of hydrophilic silicon dioxide. The resulting gels are free of the nutritionally undesirable high-melting glycerides of saturated fatty acids that serve to thicken the oils described in Heine et al.

Shoaf et al. in U.S. Pat. No. 3,669,681 describes the use of a polyol and colloidal silicon dioxide to thicken edible to provide shortenings. As noted above, hydrophobic and hydrophilic silicon dioxides differ markedly in their chemical properties and in their utilities. Even though Shoaf et al., does not specifically state which type of silicon dioxide is to be used, Shoaf et al. describes the addition of 2% and 13% by weight water in the described shortening preparations (see Examples II and V). Applicant finds that when even small amounts of water (i.e., more than 1% by weight) are introduced into a vegetable oil containing hydrophilic silicon dioxide and polyol (e.g., 2% by weight fumed silica and 0.2%-1.0% glycerol) the water interferes with gel formation. Therefore, the inclusion of substantial amounts of water in shortening preparations described in Shoaf et al. indicates that hydrophobic rather than hydrophilic silicon was used. In contrast, the present invention specifies the use of hydrophilic microparticulate silicon dioxide. That selection makes the present compositions orally dispersible. If, however, hydrophilic silicon dioxide were to be used in the recipes of Shoaf et al. such as those shown in Examples II and V of that patent, due to the effects described herein resulting from the presence of substantial amounts of water, the Shoaf et al. compositions would not even function as claimed therein. Thus, the present invention provides a significant improvement by reducing or eliminating the water that weakens or even prevents hydrophilic silica gel formation in edible oil-based food products. Furthermore, the present invention allows moderate concentrations of hydrophilic microparticulate silicon dioxide to form highly viscous gels. This is important because food products must remain in compliance with U.S. FDA regulations that restrict silicon dioxide concentrations to 2% by weight of the final food product. Thus, emphasizing the distinction between the shortenings of Shoaf et al and the present compositions, the presently invented gels specifically incorporate hydrophilic silica, and at a level not greater than 2% by weight, with generally no more than 1% polyol and no more than 1% by weight water, thus allowing the gel structure is to be stable as applied to a food item while being orally dispersible. The present composition also generally specifies a ratio of polyol to silica ranging from approximately 1:20 to 1:2.

Perlman, U.S. Pat. No. 5,962,064, describes peanut butter (a comminuted peanut suspension that, by nature, contains approximately 50% by weight particulate peanut solids and 50% by weight peanut oil), in which the peanut butter is partially hardened to prevent oil separation by addition of either silicon dioxide or polyol or optionally both. In contrast, the present edible oil-based compositions do not contain such high levels of solids; instead, in the absence of the silicon dioxide and polyol combination, they would be liquids at temperatures above the melting point of the oil.

El-Nokaly et al., U.S. Pat. No. 5,370,892, describes a non-digestible fat useful in formulating, for example, reduced calorie fat cooking and salad oil compositions made by combining a non-digestible oil having a melting point below about 37 degrees C. and a sufficient amount of hydrophobic colloidal silica (e.g., from 0.5% to about 15%) that is made by chemically modifying the Si-OH groups on the surface of the silica using halosilanes, alkoxysilanes, silazanes and siloxanes. While also thickening oils, the hydrophobic silica particles differ from the hydrophilic silicas used in the present invention, in repelling water and having substantially reduced Si-OH group density.

El-Khoury et al., U.S. Pat. No. 6,403,144, describes a food preparation composition and a process (U.S. Pat. No. 6,544,574) in which the composition has a reduced number of calories, is anti-foaming when used in frying, and provides anti-stick, anti-spatter, and browning properties. The composition includes an anti-stick agent such as lecithin and/or fumed silica, a flavor enhancing agent (e.g., MSG, nucleotides and maltol), and an anti-foam agent such as fumed silica or silicone polymer may further include at least one edible oil in which about 1.5% to about 2.2% of the hydrophilic fumed silica is added and homogenized into the oil base, after which the additional ingredients are added. However, the described composition lacks simple polyols that are important to forming oil gels of the present invention.

Thus, no prior art publications of which Applicant is aware describe the advantages of using specifically hydrophilic microparticulate silicon dioxide combined with an edible oil-soluble polyol such as glycerol in a substantially water-free, edible oil (triglyceride) environment. Applicant utilizes a very limited yet sufficient amount of an edible polyol (a molecule possessing at least two available —OH groups), preferably glycerol at a level of approximately 1% by weight or less of the oil, in combination with up to approximately 2% by weight silicon dioxide. The ratio of polyol to hydrophilic silicon dioxide is typically not greater than 50% by weight.

Regarding the importance of selecting hydrophilic or alternatively hydrophobic microparticulate silicon dioxide, various patent references clearly distinguish the type of microparticulate silica that is to be used (and/or its unique commercial designation). For example, El-Nokaly et al., U.S. Pat. No. 5,370,892, specifies the use of hydrophobic silicon dioxide in conjunction with reduced calorie fat blends, while Shuford et al., U.S. Pat. No. 4,375,483, describes a flavor-enhancing fat composition utilizing a hydrophilic silicon dioxide. On the other hand, Heine et al., U.S. Pat. No. 4,605,563, provides a commercial designation (i.e., Aerosil®200 of Degussa A.G.) that the literature shows to be hydrophilic silicon dioxide).

The present invention provides a substantially water-free gelled oil mixture that is used as a coating (e.g., a flavor coating or glaze or topping) on foods rather than a shortening ingredient for use in other foods. Applicant has discovered that by utilizing only hydrophilic colloidal silicon dioxide such as Cab-O-Sil® grade M-5 fumed silica, and by largely excluding water, a stable but orally dispersible gel can be obtained using a reduced amount of silicon dioxide and a reduced weight ratio of polyol to silicon dioxide. That is, for oil gels formulated without water, Applicant has found that the concentration of polyol, e.g., glycerol, can be chosen to be sufficient to enhance gel firmness, but not so great that excessive oil weeping (gel syneresis) occurs during storage and heating. In turn, limiting the amount of polyol beneficially limits the sweetness contributed by polyols such as glycerol for non-dessert applications. For example, Applicant's tests show that fat-borne glycerol levels substantially greater than 1% by weight are perceived as sweet.

Another advantage of minimizing water content in the present gels, and also using an oil-soluble polyol such as glycerol is that the resulting gel medium and food product can remain substantially transparent. If substantially more than 1% by weight water is included, the resulting dispersion/emulsion becomes translucent or even opaque. With a clear oil gels however, particles of flavoring agents such as spice flakes, onion flakes, cheese particles, and the like that are added, are attractively suspended in the gel rather than settling to the bottom of the container. This stable suspension is also functional since it obviates the need to shake the mixture before using.

A further benefit derived from using hydrophilic silica is that the mouth feel of fat-based gels is improved over those utilizing hydrophobic silica. In addition, by limiting the amount of hydrophilic silicon dioxide to 2% by weight, and using a reduced proportion of polyol relative to silica, Applicant finds that all ingredients can be more easily homogenized with the oil in one step rather than the sequential steps of Shoaf et al.

As an option, to help prevent the possibility of microbial growth resulting from addition of aqueous ingredients to oil gels of the present invention (regardless of whether the ingredient is dried onion powder, garlic powder, herb flakes, cheese particles and the like) the flavorant may be pre-equilibrated with a mildly acidic agent. This acid treatment can beneficially reduce the pH of the added ingredient to between approximately pH 2 and pH 4 before it is added to the oil. A weak acid or a combination of an acid and an appropriate salt of that acid can provide an acid buffered environment. Typical edible acids include the following: acetic (vinegar), citric, fumaric, lactic, malic, phosphoric, tartaric and sodium acid sulfate as well as salts of these acids, and combinations thereof.

The oil-based gels of the present invention can be used as stand-alone condiments, coatings and glazes such as olive oil-based condiment gels that may be squeezed out of a flexible walled container and applied to bread, potatoes, vegetables and meat much like ketchup or butter. To facilitate manufacture, Applicant has found that an edible oil or blend of oils including olive oil, canola oil, corn oil and the like can be combined with hydrophilic silicon dioxide, e.g., fumed silica, and polyol, e.g., glycerol, in a single mixture and co-homogenized in a single step rather than in successive steps as taught in the prior art.

Hydrophilic silicon dioxide as employed in the present invention, is available in a variety of finely divided, i.e., microparticulate, forms including amorphous fumed silica, silicon dioxide, amorphous silica gel, silica hydrogel, precipitated silica, colloidal silica, silica aerogel and crystalline silica.

To put mineral silica (SiO₂) into a natural context, silica has been shown to be an essential mineral for plant and animal development including human bone and cartilage development, and is present in the diet naturally within vegetable materials, primarily in the form of silicon dioxide, silica gel and soluble silicic acid. Exogenously added silicon dioxide is generally recognized as safe (GRAS), and has been a food additive constituent for over 40 years. It is explicitly approved as a direct food additive at levels up to 2% by weight (measured as the anhydrous SiO₂ content) under the published FDA guidelines. In the present invention, beyond its utility as a thickening agent, the presence of 2% silicon dioxide is justified by its ability to prevent oil foaming in the use of the present invention during heating of the oil-based gels [see Title 21 Subchapter B, Part 173 “Secondary Direct Food Additives Permitted in Food for Human Consumption” Subpart D-Specific Usage Additives, Section 173.340 Defoaming Agents-listing silicon dioxide]. Furthermore, silicon dioxide helps to prevent settling and caking of solid particulate flavoring agents added to the oil-based gels in the present invention [see Subchapter B, Part 172 “Food Additives Permitted for Direct Addition to Food for Human Consumption” Subpart E-Anticaking agents, Section 172.480-listing silicon dioxide].

Several different commercial products of food grade SiO₂ meeting all of the FDA requirements for a direct food additive are available. Among these are two products known as fumed silica and silica gel. Fumed silica is an ultra-fine, microparticulate amorphous form of silica (primary particle diameter, less than 0.03 microns) and is available as Cab-O-Sil® (manufactured by the Cabot Corporation). The Cabot Corporation (Tuscola, Ill.) in a technical data brochure entitled “Cab-O-Sil® Fumed Silica as a Conditioning Agent for the Food Processing Industry” (dated October 1989) lists recognized uses of fumed silica in the food processing industry. These include improving the flow of powders, adsorbing moisture, reducing caking of powders, preventing waxy food congealing, improving dispersion of dry powders in liquids, acting as a dry carrier (e.g., with flavor oils) to convert liquids into flowing powders, acting as a food grinding agent, and acting as a clarifying agent for wines and fruit juices. Fumed silica particles tend to form extended hydrogen-bonded chains and loose aggregates (via the silanol Si—OH groups), particularly in non-polar non-hydrogen bonding liquids. Because the particles are essentially non-porous, surface bonding interactions with other substances (solid particles, liquids, and even gasses) tend to predominate. Silica gel materials, on the other hand being microporous, are physically distinct from fumed silica. This porosity property allows internal absorption of liquids and internal adsorption of gasses. With microparticulate silica gel, bonding of substances can occur internally, externally and between particles. Finely divided amorphous silica gel is available, for example, as Syloid® (diameter, 3-4 microns) and Sylox® (diameter, 2 microns), as manufactured by GraceDavison, Inc. (Baltimore, Md.).

FDA Regulations. It is noted that the concentrations of silica cited above that are useful in edible oils are typically less than 2.0% by weight. The use of microparticulate fumed silica has been approved by the US FDA for many food applications as a direct food additive at levels up to 2% by weight. More specifically, silica has been approved as a de-foaming agent under Title 21 CFR section 173.340. Therefore, when added to an oil coating, e.g., olive oil that is applied to foods being baked, the silica helps prevent oil foaming as steam escapes from foods containing moisture. In addition, silica has been approved as an anti-caking agent for grated cheese and ground herbs and spices to prevent particles from adhering to one another. The fumed silica maintains these ingredients in suspension, and thereby prevents these ingredients from settling out of the oil and caking.

Cost Factors and Production. The price of SiO₂ (purchased in large commercial quantities) currently ranges from approximately $1.50 per pound (for typical microparticulate silica gels) to $3.50 per pound (for microparticulate fumed silicas) depending upon the particle size, commercial source, manufacturing process, etc. If 2% by weight fumed silica is used in a vegetable oil product, the silica would add approximately 7 cents per pound to the cost of the vegetable oil material. This cost can be compared with the cost of common edible oils in bulk that may vary between 30 and 40 cents per pound. The cost of adding a polyol component such as 0.5% glycerol to a vegetable oil is negligible. Standard food processing machinery such as high shear emulsion mills that are used in preparing mayonnaise and other food emulsions may be used in the manufacture of the gels described herein.

Flavor Enhancers. As indicated above and in Example III, flavor enhancers can be advantageously included in the present gelled edible oil-based compositions. It was surprisingly discovered that the present compositions are particularly adapted to the use of combinations of water-soluble flavor enhancers. One such combination is described in Example III, where a combination of table salt and yeast extract is included in the composition. It was observed that the presence of the yeast extract potentiated the salt flavor, as well as flavors of other components in the composition. Thus, the combination of flavor enhancers in an orally dispersible (more generally water dispersible) gelled oil-based composition which is substantially free of water results in an unexpected flavor enhancement.

Without being limited to a particular mechanism, it is believed that in the present compositions which are edible oil-based and substantially free of water, water soluble flavor enhancers have very low solubility in the oil and therefore a significant proportion (likely most) of such flavor enhancers remain in particulate form suspended in the bulk oil component. As explained above, the present compositions are orally dispersible, with the gel being at least partially liquefied by the aqueous fluid in a person's mouth. Upon dispersion in the person's mouth, the particulate flavor enhancers come in contact with the aqueous fluids, resulting in locally high concentrations on the tongue. The result is that relatively low concentrations of flavor enhancers, and specifically relatively low concentrations of table salt, provide surprisingly great flavor enhancement levels.

The application of flavor enhancers and orally dispersible edible oil-based gels is not limited to the present compositions. Indeed, the invention also concerns application of this approach in any food composition which includes immobilization of oil using a silicon dioxide-polyol combination such that flavor components and flavor enhancers carried in that oil are orally dispersible. For example, such food compositions may have higher additional solids content than indicated for the present gelled edible oil-based compositions, e.g., such that the composition is a paste, spread, semi-solid, or solid. In such high solids compositions, the additional solids may constitute 26-49% by weight, 50-60% be weight, 50-70% by weight, or even more.

A variety of flavor enhancers and flavor enhancer combinations can be used. Such flavor enhancers include, for example, sodium chloride, i.e., table salt (and potassium chloride), a number of different nucleotide flavor enhancers (such as guanylates, inosinates, salts of 5′-ribonucleotides, and corresponding acids), amino acid flavor enhancers (such as glutamic acid, glycine, and L-theanine, and their corresponding salts), maltol and derivatives such as ethyl maltol, and various natural products and extracts (such as yeast extract, seaweed extract, and the like. As indicated, potentiating or synergistic effects can be obtained using combinations of flavor enhancers. Such combinations may include sodium chloride or potassium chloride with one or more of the nucleotide flavor enhancers and/or one or more of the amino acid flavor enhancers, or with a yeast or seaweed extract. Particular embodiments include sodium chloride and/or potassium chloride with a yeast extract, a glutamate, a guanylate, an inosinate, or one or more 5′-ribonucleotides or their salts. Of course, other combinations can also be used.

In particular embodiments, the combination of flavor enhancers includes from 0.1% to 3%, 0.2% to 2%, 0.25% to 1.5%, or 0.3% to 1% by weight sodium chloride or potassium chloride powdered sodium chloride. Preferably the sodium chloride or potassium chloride is powdered, e.g., 150 to 500 mesh, such as pulverized extra fine 200or 325 mesh salt, and from 0.01 to 1% by weight of a second flavor enhancer (e.g., a flavor enhancer as indicated in the preceding paragraph. More often the second flavor enhancer is between 0.015% and 0.5%, 0.02% and 0.4%, or 0.025% and 0.1% (e.g., a yeast extract).

The following are non-limiting examples of the compositions and methods used in the instant invention.

### EXAMPLES

### Example 1

### Considerations in Formulating Edible Oil Gels Containing Hydrophilic Silica and Polyol

Microparticulate hydrophilic silicon dioxide (SiO₂) has a very large surface area (up to approximately 400 m²/gm) as well as being surface-active. The efficacy of silicon dioxide particles in thickening and gelling an edible oil can be enhanced by thorough dispersal of the microscopic particles in the edible oil, and by creating a hydrogen-bonded network of particles by the bridging action of polyol molecules (such as glycerol or propylene glycol) with the silanol (—Si—OH) groups on the surface of the particles. Applicant has observed that too great a concentration of polyol (as well as too little) that has been dispersed in edible oils can undesirably diminish gel formation. Also the addition of water will interfere with the formation of these oil gels. It is likely that the hydrogen-bonded network of particles is delicate and that water molecules will bond to the silanol groups on hydrophilic silica particles, and interfere with the bridging action of polyol molecules such as glycerol that is soluble (up to 4% by weight) in the oil. Interestingly, excess levels of polyols appear to be undesirable, and for example, glycerol concentrations exceeding approximately 1% by weight begin to diminish the oil gel's stability when combined with approximately 2% by weight microparticulate silicon dioxide.

On a weight basis, an amorphous fumed silica such as Cab-O-Sil® EH-5, whose particle size is very small (0.007 microns in diameter) and surface area is great (380 m²/gm), can be useful, as well as Cab-O-Sil® M-5 whose particle diameter is somewhat larger (approximately 0.014 microns) and surface area somewhat smaller (200 m²/gm). The Cab-O-Sil® silicas are, in turn, more efficient than silica gels having a 2-4 micron particle diameter, and produce a gelled oil composition having superior texture. Generally, the minimum but sufficient quantity of SiO₂ (which, when combined with polyol produces a thixotropic gel that will remain immobilized on food) should be utilized.

### Example 2

### Edible Oil Gels Containing Olive Oil, Fumed Silica and Glycerol

As an illustration of the present invention, between approximately 1.0% and 2% by weight microparticulate hydrophilic silicon dioxide (Cab-O-Sil® brand M5 hydrophilic fumed silica, Cabot Corporation, Tuscola, Ill.) and between approximately 0.1% and 1.0% by weight glycerol, were co-homogenized in extra virgin olive oil (Bertolli brand, Secaucus, N.J.) using a cost-effective homogenization method, e.g., high shear blending. Emulsion milling and high pressure mixing could also be used. While glycerol levels of up to approximately 4% by weight were found to be soluble in edible vegetable oils, considerably lower levels were preferred. Accordingly, 2.0% by weight M5 fumed silica and 0.5% by weight glycerol were used for gelling the above-mentioned 100% olive oil. Similarly, the same proportions of silica and glycerol were used with high oleic canola oil, soybean oil and blends that contained between 10% and 50% olive oil and between 50% to 90% high oleic canola oil. All of the above mixtures formed thixotropic heat-stable gels. While a dispersal of 2% by weight M5 fumed silica in 100% olive oil produced a somewhat thickened oil mixture (without adding glycerol), the oil remained substantially fluid at room temperature rather than gelling. By contrast, the same M5 silica-supplemented olive oil that was further supplemented with 0.5% glycerol (co-dispersed by high shear mixing in a Waring blender) gelled to a degree that it remained immobilized on essentially vertical food surfaces such as the side surfaces of oven roasts of pork, beef and roasting chickens. Surprisingly, these coatings remain immobilized on the meat surfaces rather than melting and flowing away, even as the food was baked at oven temperatures (350° F.). While it might be anticipated that this immobilized heat-stable oil coating would have a thick and greasy mouth feel after baking, the oil coating, to the contrary, readily dispersed in ones mouth during eating. The oil coating provides an agreeable and buttery mouth feel that is superior to conventional solid shortenings produced by blending vegetable oils with hard fats such as stearin or hydrogenated soybean oil.

### Example 3

### Edible Oil Gels Containing Savory Flavoring Ingredients

The thixotropic olive oil gels containing hydrophilic fumed silica (M5) and polyol (e.g., glycerol) described in Example 2 were used as a vehicle for flavoring ingredients to produce finished food compositions, and in particular, gelled olive oil and gelled oil blend condiment dressings (aka condiment glazes).

For example, flavorings such as spices (dried herbs, garlic powder, onion powder) and grated cheeses were added to olive oil and blended canola oil-olive oil-based gels. More specifically, an Italian herb-containing glaze was prepared by dispersing approximately 1%-2% by weight of an herbal mixture of oregano, basil, rosemary and parsley, approximately 1%-2% by weight of garlic powder, between 0.25% and 2% (preferably approximately 0.5%) by weight powdered sodium chloride (e.g., pulverized extra fine 200 or 325 mesh salt obtained from Morton Salt, Inc., Chicago, Ill.), and between 0.025% and 0.1% yeast extract as a flavor enhancer (e.g., Maxarome Select from DSM Food Specialties, Eagleville, Pa.) into a blended vegetable oil-based gel. The latter gel contained either approximately 97.5% by weight extra virgin olive oil (or a blend of 80% by weight high oleic canola oil and 17.5% olive oil), 2.0% by weight M5 fumed silica and 0.5% by weight glycerol.

Similarly, Applicant prepared an Italian cheese, garlic and red pepper glaze in the above-described gelled oils. The recipe contained approximately 1.5% by weight garlic powder, approximately 1.0% by weight hot red pepper flakes and between 4% and 8% by weight of a Parmesan-Romano grated cheese mixture. The grated cheeses were first dried with warm air to eliminate excess moisture and sieved through 16 mesh screen before dispersal in the gelled oil. In addition, approximately 0.4% by weight pulverized extra fine salt and 0.1% yeast extract (see above) were added to enhance the flavor. These gels provided savory gelled oil coatings for applying to heated (and unheated) Italian bread, pizza, bruschetta and crackers, or for coating meats, poultry and fish. Unlike liquid olive oil that rapidly soaks into porous foods such as breads, or runs off non-porous foods such as meat, the spreadable gels described herein have the desirable property of remaining substantially immobilized on the surface of the coated food. This property results in a more cost-effective use of the oil product, as well as a reduced caloric intake by an individual using the gelled product compared to using simple liquid oil products.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, edible oil gels that are constituted using other microparticulate hydrophilic silica sources not listed herein, or polyols not listed herein, or a combination of two or more complementary silica sources and/or complementary polyol sources to produce edible oil-based gels fall within the scope of the present invention. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A substantially water-free edible oil-based gel composition for food use, comprising
between 74% and 99% by weight triglyceride-based edible oil,
between 1.0% and 2.0% by weight hydrophilic microparticulate silicon dioxide,
between 0.1% and 1.0% by weight of at least one edible polyol,
less than 25% of additional suspended solids, and
less than 1% by weight of available water.
wherein said polyol and said silicon dioxide have been fully dispersed in said composition causing gelting of said edible oil.

2. The composition of claim 1 wherein said composition is selected from the group consisting of condiments, glazes, spreads and toppings that are applied directly to food products, and not used as a shortening ingredient in other foods.

3. The composition of claim 1 wherein said composition is stable when heated, and remains gelled at 180° C.

4. The composition of claim 1 wherein said polyol is soluble in said edible oil.

5. (canceled)

6. (canceled)

7. The composition of claim 1 wherein the primary particle diameter of said silicon dioxide is between approximately 0.005 and 0.050 microns.

8. (canceled)

9. The composition of claim 1 wherein said polyol is selected from the group consisting of polyhydric alcohols, esters of polyhydric alcohols and combinations thereof.

10. (canceled)

11. the composition of claim 1 wherein said polyol is glycerol.

12. (canceled)

13. The composition of claim 1 wherein ratio of said polyol to said ailicon dioxide is between 1:20 and 1:2, wherein both enhanced gelling and reduced oil release from siad composition is achieved.

14. (canceled)

15. The composition of claim 1 wherein at least one flavoring ingredient is added to said composition.

16. (canceled)

17. (canceled)

18. The composition of claim 1, wherein a combination of flavor enhancers is included in said composition.

19. (canceled)

20. A substantially water-free gelled edible oil-based composition for food use, comprising
between 74% and 99% by weight triglyceride-based edible oil.
a combination of hydrophilic microparticulate silicon dioxide and at least one soluble polyol sulficient to provide gelling of a mixture of said oil, silicon dioxide, and polyol, wherein the weight ratio of polyol to silicon dioxide is from about 1:2 and said composition is orally dispersible.
a level of additional suspended solids which is sufficiently low that a blend of said additional suspended solids and said edible oil remains a liquid at a temperature 10 degrees above the melting point of said edible oil, and
sufficiently low available water such that said available water does not substantially reduce the viscosity of said oil-based gel,
wherein said polyol and said silicon dioxide have been fully dispersed in said composition causing gelling of said edible oil.

21. (canceled)

22. A method for preparing a substantially water-free, gelled oil-based food coating composition that comprises between 74% and 99% by weight triglyceride-based edible oil, between 1.0% and 2.0% by weight hydrophilic microparticulate silicon dioxide, between 0.1% and 1% by weight of at least one edible polyol, and less than 1% by weight of chemically available water, comprising the steps of:
adding to a triglyceride-based edible oil, between 1.0% and 2.0% by weight microparticulate hydrophilic silicon dioxide, and between 0.1% and 1% by weight of at least one edible polyol.
and
homoenizing the mixture until said silicon dioxide and said polyol are fully dispersed in said oil.

23. The method of claim 22 wherein a first homogenizing step is performed after adding said silicon dioxide but before adding said polyol, and a second homogenizing step is performed after adding said polyol, wherein said silicon dioxide and siad polyol are fully dispersed in said oil.

24-36. (canceled)

37. The method of claim 22 wherein at least one flavoring ingredient is added to said composition.

38-41. (canceled)

42. The method of claim 22, wherein a combination of flavor enhancers is added to said composition.

43. A method for preparing a coated prepared food item, comprising:
applying to said food item a flavored substantially water-free gelled edible oil-based composition for food use,
wherein said gel composition comprises:
from 4% to 99% by weight triglyceride-based edible oil,
from 1.0% to 2.0% by weight hydrophilic microparticulate silicon dioxide,
from 0.1% to 1.0% by weight of at least one edible polyol,
less than 25% of additional suspended solids, and
less than 1% by weight available water,
and wherein said polyol and siad silicon dioxide have been fully dispersed in said composition causing gelling of said edible oil.

44. The method of claim 43, wherein said gel composition is applied before cooking.

45. The method of claim 43, wherein said gel composition is applied after cooking.

46-48. (canceled)

49. A coated prepared food item, comprising:
a flavored, substantially water-free, edible oil-based gel composition coating, wherein said gel composition coating comprises:
between 74% and 99% by weight triglyceride-based edible oil,
between 1.0% and 2.0% by weight hydrophilic micorparticulate silicon dioxide,
between 0.1% and 1.0% by weight of at least one edible polyol,
less than 25% of additional suspended solids, and
less than 1% by weight of available water.

50. The coated prepared food item of claim 49, wherein said food item i selected from the group consisting of meat, poultry, fish, vegetables, pizza, brushetta, sliced italian and French breads, bagels, croutons, and toast.
